(19) United States
(12) Patent Application Publication
(10) Pub. No.: US 2008/0291807 A1
(43) Pub. Date: Nov. 27, 2008

(54) Hologram Record Carrier and Record Reproducing Method and System

(75) Inventors: Yoshihisa Itoh, Saitama (JP); Masakazu Ogasawara, Saitama (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation, Meguro-ku, Tokyo (JP)

(21) Appl. No.: 11/579,613

(22) PCT Filed: Apr. 26, 2005
(86) PCT No.: PCT/JP2005/008388

§ 371 Date: Nov. 30, 2007

(30) Foreign Application Priority Data
May 7, 2004 (JP) 2004-138252

(51) Int. Cl. G11B 7/00

(52) U.S. Cl. 369/103

(57) ABSTRACT

A hologram recording carrier is provided with a hologram recording layer that stores inside an optical interference pattern made by components of irradiated coherent reference light and signal light, as a diffraction grating; and a polarization selective reflection film that is arranged on an opposite side to a light irradiation plane of the hologram recording layer and reflects a second linear polarization component rotated from a first linear polarization component, without reflecting the first linear polarization component of incident light.

### TECHNICAL FIELD

The present invention relates to a recording carrier, such as an optical disk, an optical card or the like, on which information is optically recorded and/or from which information is optically reproduced, and more specifically, to a hologram recording carrier having a hologram recording layer on which information is recorded and/or from which information is reproduced by irradiation of an optical beam, and a recording and reproducing method and system.

### BACKGROUND ART

Hologram for recoding two-dimensional data with high density for high-density information recording has come into the spotlight. A hologram is characterized by recording a wavefront of light carrying record information on a recording carrier, which is made of a photosensitive material such as a photorefractive material, volumetrically with variation of a refraction index. A hologram recording carrier allows remarkable increase of recording capacity through multi-recording. A multi-recording approach, which includes angle multi-recording, phase coding multi-recording, etc., allows multi-recording of information by changing an incident angle or a phase of an interfering light wave even in an overlapped hologram region. For example, a hologram recording and reproducing system using a hologram recording carrier with a disk-like laminated reflective film has been developed (see Japanese Unexamined Patent Application Publication No. 11-311937).

In such a hologram recording and reproducing system, reference light passes through a hologram recording layer and is converged as a spot on the reflective film, and the reference light reflected on the reflective film diverges and passes through the hologram recording layer, while an information light beam carrying information to be recorded passes through the hologram recording layer. Then, the reflected reference light interferes with the information light to produce an interference pattern in the hologram recording layer, thereby recording holograms in the hologram recording layer volumetrically. These holograms having the interference pattern are adjacent to each other and overlap each other in the hologram recording layer. Also, reproduction light reconstructed from each of the holograms by radiating the reference light is detected and demodulated to reproduce recorded information.

In a hologram recording and reproducing system in which reference light and information light are incident from the same side along the same axis, it is difficult to separate the reference light reflected on a reflective film from reproduction light emitted from holograms for reproduction of information, which results in deterioration of readability of a reproduction signal.

To overcome this problem, the hologram recording and reproducing system disclosed in JP-A-11-311937 divides a pupil immediately before an object lens into two regions and arranges two divided light rotators (or a two-divided light rotating plate) having a difference in direction of light rotation by 90 degrees in respective regions in order to prevent the reference light from being incident into a photodetector.

### DISCLOSURE OF THE INVENTION

The system of JP-A-11-311937 has to drive the two-divided light rotating plate and the object lens integrally for record/reproduction and also has a problem of deterioration of record characteristics due to reproduction light corresponding to a division boundary of the two-divided light rotating plate.

In addition, when a hologram is to be recorded in the hologram recording carrier having the above-mentioned reflective film, four holograms are recorded by interference between four light beams, i.e., the incident reference light and signal light and the reflected reference light and signal light, which means wasteful use of the performance of the hologram recording layer. Accordingly, as the reference light is reflected by the reflective film of the hologram recording carrier when information is reproduced, it is difficult to separate the reflected reference light from diffraction light emitted from a reproduced hologram, which may result in deterioration of readability of the reproduction signal. Moreover, the reproduction signal may be deteriorated as a hologram having a reflected image is recorded in the hologram recording carrier.

The invention has been conceived to solve the above problems. It is an object of the invention to provide a hologram recording carrier, a hologram recording and reproducing method and a hologram recording and reproducing system, which are capable of allowing a stable recording and reproducing operation.

According to one aspect, the invention provides a hologram recording carrier including a hologram recording layer that stores inside an optical interference pattern made by components of irradiated coherent reference light and signal light, as a diffraction grating; and a polarization selective reflection film that is arranged on an opposite side to a light irradiation plane of the hologram recording layer and reflects a second linear polarization component rotated from a first linear polarization component, without reflecting the first linear polarization component of incident light.

According to another aspect, the invention provides a hologram recording method of a hologram recording carrier including a hologram recording layer that stores inside an optical interference pattern made by components of coherent reference light and signal light, as a diffraction grating, the method including the steps of: arranging a polarization selective reflection film on an opposite side to a light irradiation plane of the hologram recording layer, the polarization selective reflection film transmitting or absorbing a first linear polarization component of incident light, without reflecting the first linear polarization component, and reflecting a second linear polarization component rotated from the first linear polarization component; and causing a light beam including the second linear polarization component of the reference light and the signal light to be incident from the hologram recording layer into the polarization selective reflection film and to be reflected by the polarization selective reflection film.

According to another aspect, the invention provides a hologram reproducing method of a hologram recording carrier including a hologram recording layer that stores inside an optical interference pattern made by components of coherent reference light and signal light, as a diffraction grating, the method including the steps of: arranging a polarization selective reflection film on an opposite side to a light irradiation plane of the hologram recording layer, the polarization selective reflection film transmitting or absorbing a first linear polarization component of incident light, without reflecting the first linear polarization component, and reflecting a second linear polarization component rotated from the first linear polarization component; and causing a light beam including only the first linear polarization component of the reference light to be incident from the hologram recording layer into the polarization selective reflection film and to be transmitted or absorbed in the polarization selective reflection film.

According to another aspect, the invention provides a hologram recording and reproducing system including: a supporting part that detachably supports a hologram recording carrier including a hologram recording layer that stores inside an optical interference pattern made by components of irradiated coherent reference light and signal light, as a diffraction grating; a light source that emits the coherent reference light; a signal light generating part that includes a spatial light modulator for generating signal light by spatially modulating the reference light according to record information; and an interfering part that irradiates a light beam including the signal light and the reference light on the hologram recording layer, forms a region of diffraction grating by the optical interference pattern inside the hologram recoding layer, and generates reproduction light corresponding to the signal light by irradiating the reference light on the region of diffraction grating, the hologram recording carrier further including a polarization selective reflection film that is arranged on an opposite side to a light irradiation plane of the hologram recording layer and reflects a second linear polarization component rotated from a first linear polarization component, without reflecting the first linear polarization component of the light beam, and the hologram recording and reproducing system further including a polarization variable means that rotates a polarization direction of the reference light to include the second linear polarization component in the light beam for recording and include only the first linear polarization component in the light beam for reproduction.

According to another aspect, the invention provides a hologram reproducing system including: a supporting part that detachably supports a hologram recording carrier including a hologram recording layer that stores inside an optical interference pattern made by components of irradiated coherent reference light and signal light, as a diffraction grating; a light source that emits the coherent reference light; and an interfering part that generates reproduction light corresponding to the signal light by irradiating the reference light on a region of diffraction grating, the hologram recording carrier further including a polarization selective reflection film that is arranged on an opposite side to a light irradiation plane of the hologram recording layer and reflects a second linear polarization component rotated from a first linear polarization component, without reflecting the first linear polarization component of the reference light, and the hologram reproducing system further including a polarization variable means that rotates a polarization direction of the reference light to include only the first linear polarization component in the reference light.

According to another aspect, the invention provides a hologram recording and reproducing system including: a supporting part that detachably supports a hologram recording carrier including a hologram recording layer that stores inside an optical interference pattern made by components of irradiated coherent reference light and signal light, as a diffraction grating; a light source that emits the coherent reference light; a signal light generating part that includes a spatial light modulator for generating signal light by spatially modulating the reference light according to record information; an interfering part that irradiates a light beam including the signal light and the reference light on the hologram recording layer, forms a region of diffraction grating by the optical interference pattern inside the hologram recoding layer, and generates reproduction light corresponding to the signal light by irradiating the reference light on the region of diffraction grating; a polarization selective reflecting part that is arranged with a space formed on an opposite side to a light irradiation plane of the hologram recording layer and reflects a second linear polarization component rotated from a first linear polarization component, without reflecting the first linear polarization component of the light beam; and a polarization variable means that rotates a polarization direction of the reference light to include the second linear polarization component in the light beam for recording and include only the first linear polarization component in the light beam for reproduction.

According to another aspect, the invention provides a hologram reproducing system including: a supporting part that detachably supports a hologram recording carrier comprising a hologram recording layer that stores inside an optical interference pattern made by components of irradiated coherent reference light and signal light, as a diffraction grating; a light source that emits the coherent reference light; an interfering part that generates reproduction light corresponding to the signal light by irradiating the reference light on a region of diffraction grating; a polarization selective reflection film that is arranged with a space formed on an opposite side to a light irradiation plane of the hologram recording layer and reflects a second linear polarization component rotated from a first linear polarization component, without reflecting the first linear polarization component of the reference light; and a polarization variable means that rotates a polarization direction of the reference light to include only the first linear polarization component in the reference light.

### BRIEF DESCRIPTION OF THE DRAWINGS

FIG. 1 is a diagrammatic partial sectional view of a hologram recording carrier according to one embodiment of the invention.

FIG. 2 is a diagrammatic partial perspective view of a hologram recording carrier according to another embodiment of the invention.

FIGS. 3 to 6 are diagrammatic partial sectional views of hologram recording carriers according to other embodiments of the invention.

FIG. 7 is a block diagram showing a general configuration of a hologram apparatus for recording and reproducing information on/from a hologram recording carrier according to one embodiment of the invention.

FIGS. 8 to 10 are views showing a general configuration of a pickup of a hologram apparatus for recording and reproducing information on/from a hologram recording carrier according to one embodiment of the invention.

FIG. 11 is a plan view showing a portion of a photodetector in a pickup of a hologram apparatus for recording and reproducing information on/from a hologram recording carrier according to one embodiment of the invention.

FIG. 12 is a diagrammatic partial sectional view illustrating a recording process of a hologram recording carrier according to one embodiment of the invention.

FIG. 13 is a diagrammatic partial sectional view illustrating a reproducing process of a hologram recording carrier according to one embodiment of the invention.

FIG. 14 is a configuration view showing a hologram apparatus according to another embodiment of the invention.

FIGS. 15 to 17 are diagrammatic partial sectional views of hologram recording carriers according to other embodiments of the invention.

FIG. 18 is a perspective view of a hologram recording carrier disk according to one embodiment of the invention.

FIG. 19 is a perspective view of a hologram recording carrier card according to another embodiment of the invention.

FIG. 20 is a plan view of a hologram recording carrier disk according to one embodiment of the invention.

FIG. 21 is a diagrammatic partial sectional view of a hologram recording carrier according to another embodiment of the invention.

FIG. 22 is a perspective view of a hologram recording carrier according to another embodiment of the invention.

FIG. 23 is a diagrammatic partial sectional view of a hologram recording carrier according to another embodiment of the invention.

FIG. 24 is a configuration view showing a hologram apparatus according to another embodiment of the invention.

### MODE FOR CARRYING OUT THE INVENTION

Embodiments of the invention will be hereinafter described with reference to the accompanying drawings

### Embodiment 1

### Hologram Recording Carrier

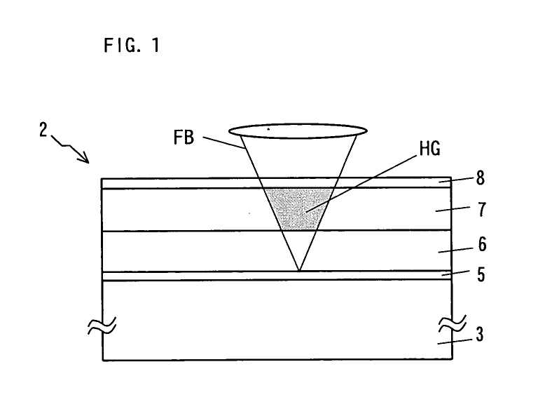

FIG. 1 shows a disk-like hologram recording carrier 2 on which information is recorded and/or from which information is reproduced by irradiation of light according to Embodiment 1.

The hologram recording carrier 2 comprises a polarization selective reflection film 5, a separation layer 6, a hologram recording layer 7 and a protective layer 8, which are stacked on a substrate 3, when viewed from an opposite side to a light irradiation side.

The hologram recording layer 7 stores therein an optical interference pattern made by a first light beam FB including components of coherent reference light and signal light for recording, as a diffraction grating (hologram). The hologram recording layer 7 is made of a transparent photosensitive material, such as a photorefractive material, hole burning material, a photochromic material or the like, which is sensitive to the first light beam FB of a sensitive wavelength band and can store the optical interference pattern. The first light beam FB includes components of the reference light and the signal light for hologram recording, while including only the component of the reference light, without the component of the signal light, for hologram reproduction.

The polarization selective reflection film 5 is a optical functional film that transmits or absorbs a first linear polarization component, for example, a P polarization component, of the first light beam FB, which is the incident light, without any reflection, and reflects a second linear polarization component, for example, a S polarization component, rotated by 90 degrees from the first linear polarization component. Alternatively, the polarization selective reflection film 5 may be a optical functional film that transmits or absorbs a first linear polarization component of the first light beam FB, which is the incident light, and reflects a second linear polarization component rotated by more than 0 degree and less than 90 degrees from the first linear polarization component, as well as by 90 degrees. The polarization selective reflection film 5 may include, for example, a reflective polarization film or an absorptive polarization film known as a polarizing plate, which is used for a liquid crystal display and the like.

The reflective polarization film reflects polarized light in a predetermined vibration direction (called predetermined polarized light) and transmits polarized light in a direction perpendicular to the predetermined polarized light (called perpendicular polarized light). The reflective polarization film has a polarization reflection axis and a polarization transmission axis. The polarization reflection axis of the reflective polarization film refers to a direction in which reflectivity becomes maximal when the predetermined polarized light is incident in a normal direction of the polarization reflection axis. The polarization transmission axis refers to a direction perpendicular to the polarization reflection axis and in which transmitivity becomes maximal. The reflective polarization film may include a reflective linear polarization film having a polarization separation function for linear polarization and a reflective circular polarization film having a polarization separation function for circular polarization. In this embodiment, the reflective linear polarization film is used as the reflective polarization film.

Also, the reflective linear polarization film may include, for example, a reflective polarization film using a reflectivity difference between polarization components by a Brewster angle, a reflective polarization film having a fine metal pattern, a reflective polarization film comprising at least two kinds of stacked polymer films and using anisotropy of reflectivity by refractivity anisotropy, a reflective polarization film having an island structure constituted by at least two kinds of polymer films and using anisotropy of reflectivity by refractivity anisotropy, a reflective polarization film having polymer films in which particles are dispersed and using anisotropy of reflectivity by refractivity anisotropy, a reflective polarization film having polymer films in which inorganic particles are dispersed and using anisotropy of reflectivity based on a difference of scattering power by the diameter of the dispersed inorganic particles, etc. A film thickness of the reflective polarization film is preferably small, particularly, less than 1 mm or 0.2 mm.

The absorptive polarization film reflects the predetermined polarized light and absorbs polarized light in a vibration direction perpendicular to the predetermined polarized light. The absorptive polarization film has a polarization reflection axis and a polarization absorption axis. The polarization reflection axis of the absorptive polarization film refers to a direction in which reflectivity becomes maximal when the predetermined polarization is incident in a normal direction of the polarization reflection axis. The polarization absorption axis refers to a direction perpendicular to the polarization reflection axis and in which absorptance becomes maximal.

The absorptive polarization film may include, for example, an iodine polarization film and a dye polarization film. The iodine polarization film refers to an extended polyvinyl alcohol film having iodine absorbed therein, and the dye polarization film refers to an extended polyvinyl alcohol film having dichroic dye absorbed therein. These polarization films have one or both sides on which a polymer film is stacked for improvement of their durability. The polymer film used herein may be made of cellulose diacetate, cellulose triacetate, polyethylene terephthalate, norbornene resin or the like. A film thickness of the absorptive polarization film is also preferably small, particularly, less than 1 mm or 0.2 mm.

The substrate 3 to support the above-mentioned films is made of, for example, glass, polycarbonate, amorphous polyolefin, polyimide, plastics such as PET, PEN or PES, ultraviolet curing acryl resin or the like. The substrate 3 requires light transmission if the reflective polarization film is used for the polarization selective reflection film 5 and may be colored in the case of the absorptive polarization film.

The separation layer 6 and the protective layer 8 are made of light transmission material and are used to planarize a stacked structure or protect the hologram recording layer 7.

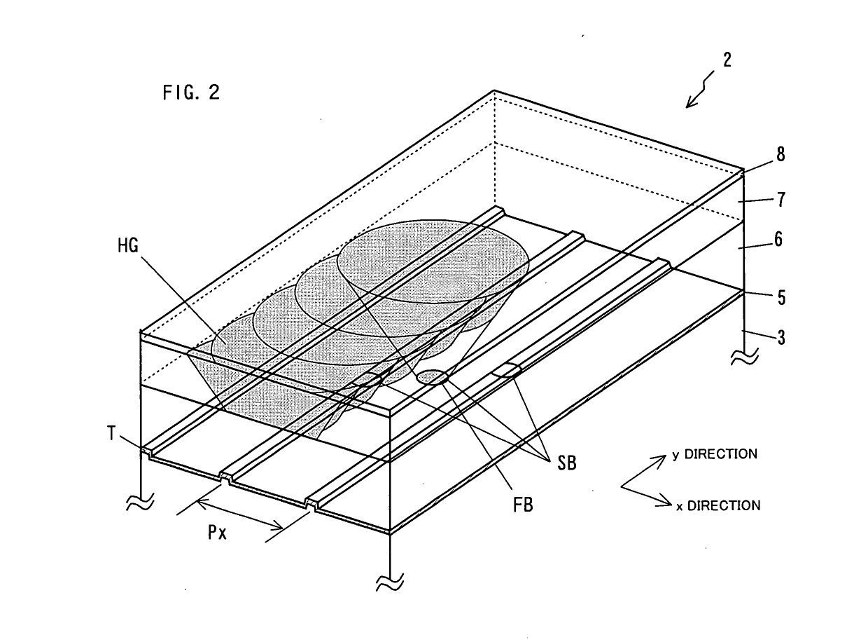

FIG. 2 shows a hologram recording carrier 2 according to another embodiment of the invention. The hologram recording carrier 2 comprises a polarization selective reflection film 5, a separation layer 6, a hologram recording layer 7 and a protective layer 8, which are stacked on a substrate 3 on which tracks are transcribed, when viewed from an opposite side to a light irradiation side. The polarization selective reflection film 5 is formed with grooves for servo as a plurality of tracks T extending without intersecting therebetween. The polarization selective reflection film 5 is used as a guide layer for servo.

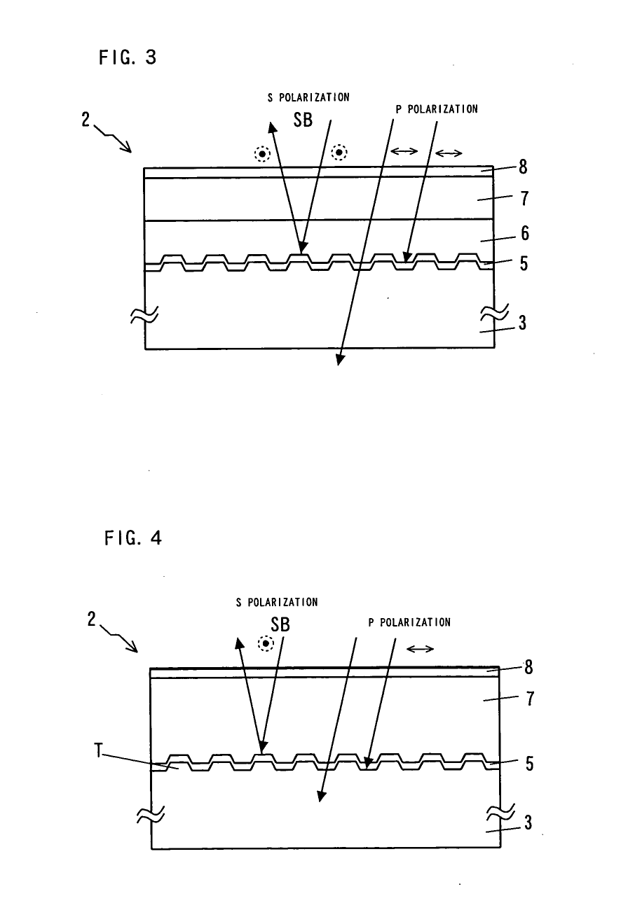

As shown in FIG. 3, the polarization selective reflection film 5 reflects a second linear polarization component, for example, a S polarization component, of a first light beam FB and transmits or absorbs a P polarization component (first linear polarization component) perpendicular to the S polarization component. Accordingly, the S polarization component is used for a servo beam SB for servo control.

The servo beam SB is a light beam having a wavelength, which is not sensitive to the hologram recording layer 7, out of a sensitive wavelength band of the first light beam FB. The servo beam is condensed to read the tracks T for servo or pits formed on the substrate 3. As shown in FIG. 2, as the servo beam SB follows the tracks T, positions on the hologram recording carrier 2 at which a hologram is recorded are determined (focus servo and xy direction servo). In this manner, the focus servo can be performed, or a tracking servo can be performed by reproducing recorded guide track signals of the grooves or pits.

For example, as shown in FIG. 2, the servo beam SB may be divided into three beams by a diffractive optical element such as a grating. Among these beam, a main beam is used to perform the focus servo while two side beams are used to perform the x-y direction servo. In other words, an optical axis of the first light beam FB is arranged and a tracking servo control is performed such that the first light beam coincides with a central light spot of the servo beam SB comprising the three beams standing in a row, and then, a hologram HG is volumetrically recorded by the first light beam FB in the hologram recording layer 7 above mirror portions between adjacent tracks T.

If the substrate 3 has a disk shape, the tracks T may be formed in a spiral or a concentric circle, or in a plurality of divided spiral arcs above the center of the disk-like substrate 3. If the substrate 3 has a card shape, the tracks T may be formed parallel to the card-like substrate 3. If the substrate 3 has a rectangular card shape, the tracks T may be formed in a spiral, a spiral arc, or a concentric circle above, for example, the center of gravity of the rectangular card-like substrate 3.

The servo control is performed by driving an object lens with an actuator according to a detected signal using a pickup comprising an optical system an so on, including a light source emitting a light beam, the object lens that condenses the light beam, as an optical spot, into the tracks on the polarization selective reflection film 5 and leads light reflected from the tracks to a photodetector. The diameter of the optical spot on the polarization selective reflection film 5 is set to be narrowed up to a value defined by a wavelength of the light beam and a numerical aperture (NA) of the object lens (This value is a so-called diffraction limit. For example, this value is 0.821/NA (1 is wavelength), but if an aberration is sufficiently small, compared to the wavelength, this value is defined by only the wavelength of the light beam and the numerical aperture). In other words, the light beam irradiated through the object lens is focused when the polarization selective reflection film 5 is placed at a waist of the light, beam. The width of the grooves are properly set depending on an output, for example, a push-pull signal, of the photodetector that receives reflected light from the optical spot.

In addition, a pitch Px (in an x direction, i.e., a direction perpendicular to an extension direction (y direction) of the tracks T) of the tracks T of the polarization selective reflection film 5, as shown in FIG. 2, is set as a distance defined by multiplicity of the hologram HG recorded above the optical spot of the first light beam FB. The maximum multiplicity in an actual shift multi-recording hologram system, that is, a value (number of times) indicating the maximum number of independent holograms recordable in the same volume of the hologram recording layer, is determined by a recording layer material, a configuration of the hologram apparatus, etc. A minimum value of the track pitch Px (i.e., a minimum shift distance) is set by a division of diameter of a hologram region by the maximum multiplicity. The track pitch Px is set above the minimum shift distance).

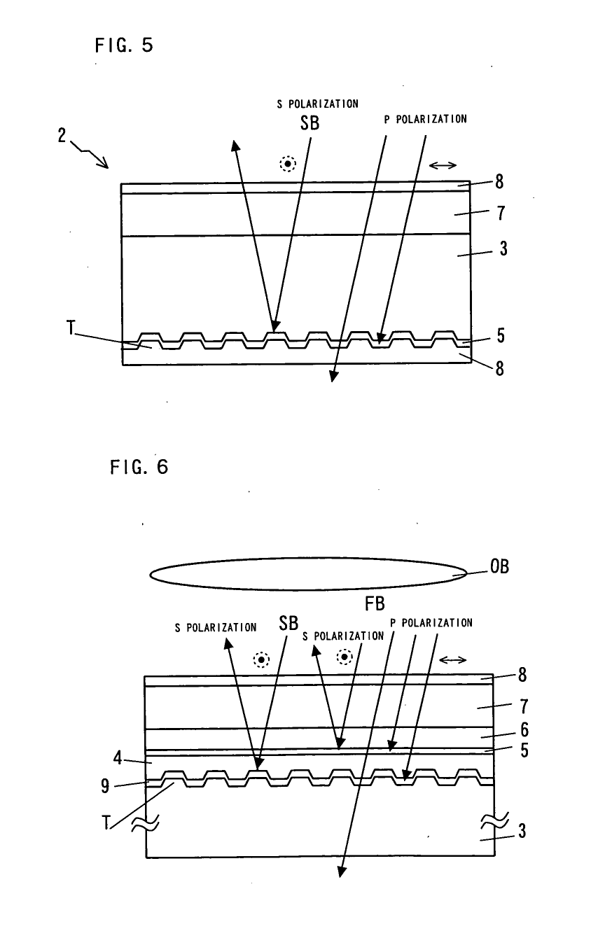

As illustrated above, the above embodiment shows the hologram recording carrier having the structure where the polarization selective reflection film 5 and the hologram recording layer 7 are stacked with the separation layer 6 interposed therebetween. As a modification, the separation layer 6 may be removed from the structure, as shown in FIG. 4. As another modification, as shown in FIG. 5, the polarization selective reflection film 5 may be stacked at an opposite side to a side at which the hologram recording layer 7 of the transparent substrate 3 is stacked, that is, the transparent substrate 3 may be interposed between the hologram recording layer 7 and the polarization selective reflection film 5 such that the substrate 3 serves as a separation layer.

FIG. 6 shows another hologram recording carrier 2 in which a wavelength selective reflection film 9 for transmitting the first light beam FB (reference light and signal light) and reflecting only a reflection wavelength band which dose not include wavelengths of the reference light and the signal light is formed at an opposite side to the light incident side of the polarization selective reflection film 5 in the above embodiment. This hologram recording carrier 2 comprises a protective layer 8, a hologram recording layer 7, a separation layer 6, a polarization selective reflection film 5, a second separation layer 4, a wavelength selective reflection film 9, and a substrate 3 on which an address or track structure is transcribed. The wavelength selective reflection film 9 has a property of reflecting a servo beam SB having a wavelength used for servo control and transmitting or absorbing a first light beam FB having a wavelength used for hologram recording without reflecting the first light beam FB. Instead of the polarization selective reflection film 5, the wavelength selective reflection film 9 is formed with grooves for servo and thus is used as a guide layer.

Since a direction of polarization of the servo beam SB is set to be a direction of polarization transmitted to the polarization selective reflection film 5, for example, S polarization, the servo beam SB transmits the polarization selective reflection film 5, arrives at the wavelength selective reflection film 9, and then is reflected by the wavelength selective reflection film 9. Then, the reflected servo beam SB passes through an object lens OB and then is incident into a photodetector for servo. As shown in FIG. 6, since the polarization selective reflection film 5 is nearer at a side of the object lens OB (at a side of light irradiation) than the wavelength selective reflection film 9, diffraction light of the first light beam FB for hologram recording by a groove structure (tracks T) of the wavelength selective reflection film 9 are not produced. Thus, an effect of the diffraction light is reduced, making it possible to reproduce a hologram with a good S/N (signal-to-noise) ratio.

In any of the above-described embodiments, the servo beam SB is condensed into the guide layer of the hologram recording carrier 2, the servo control is always performed to determine a positional relation with the hologram recording carrier 2, and the hologram reproduction and recording are performed with the first light beam FB (reference light) and the first light beam FB (reference light and signal light).

### Embodiment 2

### Hologram Apparatus

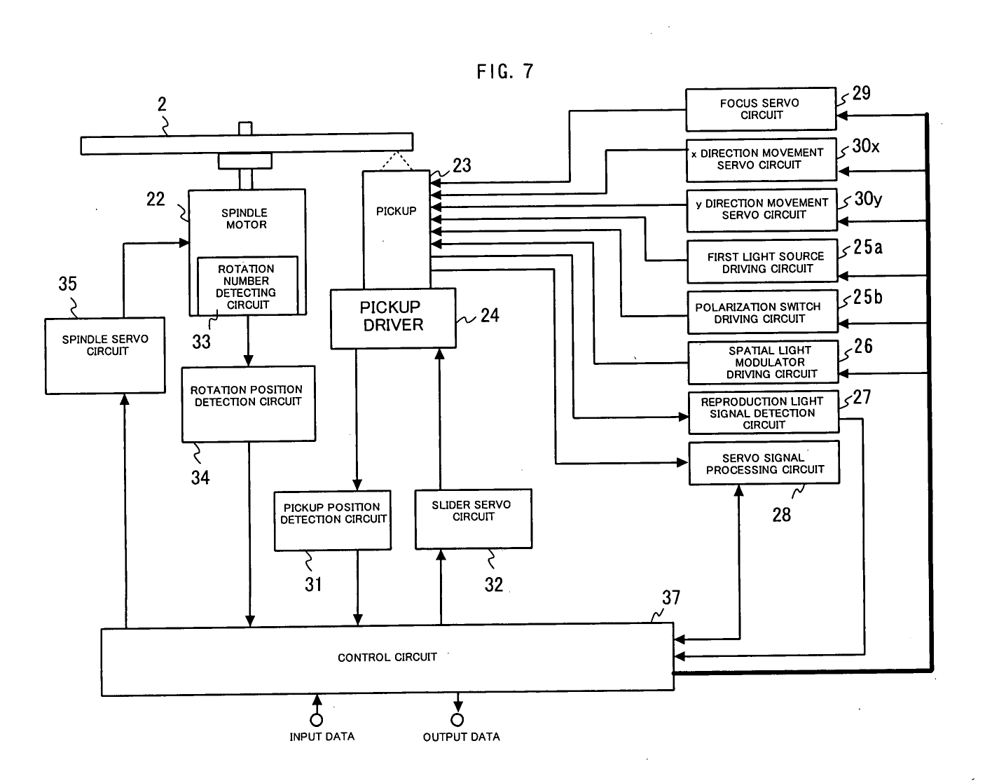

FIG. 7 shows an example of a general configuration of a hologram apparatus for recording and reproducing information of a hologram recording carrier to which the invention is applied.

As shown in FIG. 7, a hologram apparatus comprises a spindle motor 22 for rotating a turn table on which a disk-like hologram recording carrier 2 is placed, a pickup 23 for reading a signal out of the hologram recording carrier 2 by using a light beam, a pickup driver 24 for holding and moving the pickup in a radial direction (x direction), a first light source driving circuit 25a, a polarization switch driving circuit 25b, a spatial optical modulator driving circuit 26, a reproduction light signal detection circuit 27, a servo signal processing circuit 28, a focus servo circuit 29, an x direction movement servo circuit 30x, a y direction movement servo circuit 30y, a pickup position detection circuit 31 connected to the pickup driver 24 for detecting a position signal of the pickup, a slider servo circuit 32 connected to the pickup driver 24 for supplying a predetermined signal to the pickup driver 24, a rotation number detection circuit 33 connected to the spindle motor 22 for detecting a rotation number signal of the spindle motor 22, a rotation position detection circuit 34 connected to the rotation number detection circuit 33 for generating a rotation position signal of the hologram recording carrier 2, and a spindle servo circuit 35 connected to the spindle motor 22 for supplying a predetermined signal to the spindle motor 22.

The hologram apparatus further comprises a control circuit 37 connected to the first light source driving circuit 25a, the polarization switch driving circuit 25b, the spatial optical modulator driving circuit 26, the reproduction light signal detection circuit 27, the servo signal processing circuit 28, the focus servo circuit 29, the x direction movement servo circuit 30x, they direction movement servo circuit 30y, the pickup position detection circuit 31, the slider servo circuit 32, the rotation number detection circuit 33, the rotation position detection circuit 34, and the spindle servo circuit 35. Based on signals from the circuits connected to the control circuit 37, the control circuit 37 performs focus servo control, x and y direction movement servo control, reproduction position (position in x and y directions) control, etc. for the pickup through these driving circuits. The control circuit 37 may be embodied by a microcomputer incorporating various kinds of memories for control of an overall operation of the hologram apparatus. The control circuit 37 generates various control signals according to user's instructions inputted through a manipulation part (not shown) and current operation conditions of the hologram apparatus, and is connected to a display part (not shown) for informing a user of operation conditions of the hologram apparatus.

In addition, the control circuit 37 performs a process Such as coding of hologram record data inputted from the outside and controls a record order of the hologram by supplying a predetermined signal to the spatial optical modulator driving circuit 26. The control circuit 37 restores data recorded on a hologram recording carrier by performing demodulation and error correction processes based on a signal from the reproduction light signal detection circuit 27. Also, the control circuit 37 reproduces and outputs informational data by decoding the restored data.

Further, the control circuit 37 controls holograms to be formed and recorded with predetermined gaps (multi-gap).

<Pickup>

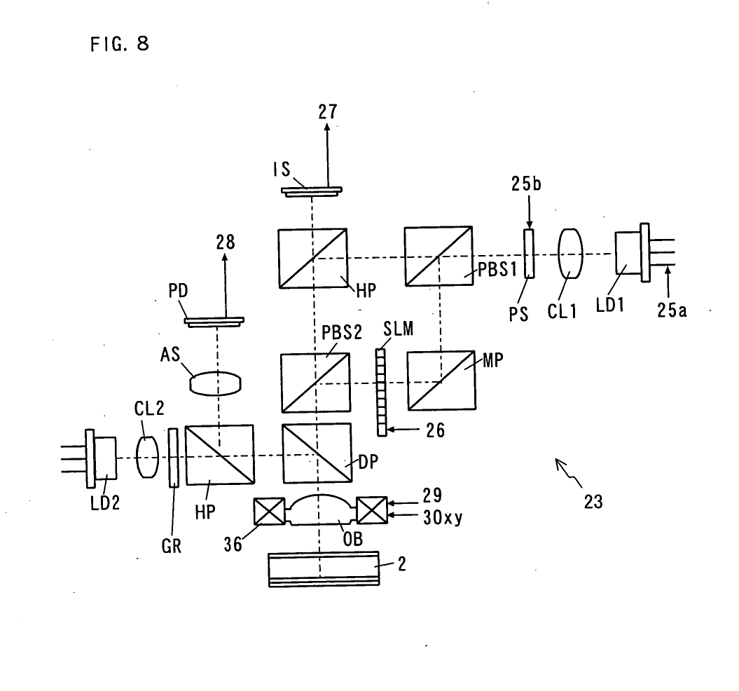

FIG. 8 shows an example of a general configuration of the pickup of the above-described hologram apparatus.

FIG. 8 exemplifies a case where a laser light source having the same wavelength is used for hologram recording/reproduction, and a laser light source having a wavelength different from a wavelength used to record the hologram is used to control relation between a hologram recording carrier 2 and a pickup 23 (focus and tracking relation).

The pickup 23 generally comprises a hologram recording and reproducing optical system, a servo system and a common system, which are arranged on a substantially common plane except an object lens OB.

The hologram recording and reproducing optical system comprises a first laser light source LD1 for hologram recording/reproduction, a first collimator lens CL1, a polarization switch PS, a first polarization beam splitter PBS1, a mirror prism MP, a spatial light modulator SLM, a reproduction light signal detecting part including an image detecting sensor IS comprising an array of CCDs or complementary metal oxide semiconductor devices, a half mirror prism HP, and a second polarization beam splitter PBS2. An image forming lens (not shown) is arranged between the half mirror prism HP and the image detecting sensor IS.

The servo system comprises a second laser light source LD2 for servo control (movement in xyz directions) of position of a light beam relative to the hologram recording carrier 2, a second collimator lens CL2, a diffraction optical element GR such as a grating for generating a multi-beam for a servo beam SB, a half prism HP, a coupling lens AS, and a servo signal detecting part including a photodetector PD.

The common system comprises a dichroic prism DP for joining the servo beam SB, signal light and reference light, and the object lens OB.

As shown in FIG. 8, the first polarization beam splitter PBS1, the mirror prism MP, the half mirror prism HP and the second polarization beam splitter PBS2 are so arranged that their respective functional planes are in parallel to each other. These optical components are so arranged that optical axes (indicated by dash-dot lines) of optical beams from the first and second laser light sources LD1 and LD2 extend to the hologram recording and reproducing optical system and the servo system, respectively, and substantially coincide with each other in the common system.

The first laser light source LD1 is connected to the first light source driving circuit 25a that controls power of the first laser light source LD1 such that intensity of the first light beam FB becomes increase for hologram recording and becomes decrease for hologram reproduction. The second laser light source LD2 is connected to a second light source driving circuit (not shown) that controls power of the second laser light source LD2 such that intensity of the servo beam SB having a wavelength different from a wavelength of the first laser light source LD1 is controlled.

The polarization switch PS is connected to the polarization switch driving circuit 25b and rotates a polarization plane of the first light beam FB passing therethrough. The polarization switch driving circuit 25b adjusts a rotation angle of the polarization plane to switch at the time of hologram recording and reproduction. Polarization variable means such as the polarization switch driving circuit 25b and the polarization switch PS may be an optical device to rotate a polarization direction of a light beam emitted from a laser light source by a predetermined angle, for example, 90 degrees. For example, the polarization variable means may be a transmission type liquid crystal panel, or a ½ wavelength plate having a support mechanism to coincide an optical axis of the light beam with a line perpendicular to a main surface of the ½ wavelength plate and rotate the ½ wavelength plate around the optical axis. In addition, the polarization switch PS may be a device that changes polarization of transmission light of electro-optic crystals into perpendicular linear polarizations when a voltage is applied to the electro-optic crystals.

The spatial light modulator SLM of a transmission type comprises a liquid crystal panel having a plurality of pixel electrodes in the form of a matrix and has a function of electrically shielding some of incident light every pixel or a function of transmitting the entire incident light to make a non-modulation state. The spatial light modulator SLM is connected to the spatial light modulator driving circuit 26 and generates signal light by modulating and transmitting the light beam to have a distribution based on page data to be recorded (information pattern of two-dimensional data such as a brightness dot pattern on a plane).

The reproduction light signal detecting part including the image detecting sensor IS is connected to the reproduction light signal detection circuit 27.

In addition, the pickup 23 is provided with an object lens actuating part 36 including a 3-axis actuator to move the object lens OB in a direction parallel to its optical axis (z direction), a direction parallel to tracks (y direction) and a direction perpendicular to the tracks (x direction).

The photodetector PD is connected to the servo signal processing circuit 28 and has light receiving elements for focus servo and x and y direction movement servo, for example. Output signals, such as a focus error signal and a tracking error signal, from the photodetector PD are supplied to the servo signal processing circuit 28.

The servo signal processing circuit 28 generates a focusing driving signal from the focus error signal and supplies the generated focusing driving signal to the focus servo circuit 29 through the control circuit 37. The focus servo circuit 29 drives a focusing portion of the object lens actuating part 36 equipped in the pickup 23 according to the focusing driving signal. Then, the focusing portion operates to adjust a focus position of a light spot irradiated on the hologram recording carrier.

In addition, the servo signal processing circuit 28 generates x and y direction movement driving signals and supplies these signals to the x direction movement servo circuit 30x and the y direction movement servo circuit 30y, respectively. The x direction movement servo circuit 30x and the y direction movement servo circuit 30y drive the object lens actuating part 36 equipped in the pickup 23 according to the x and y direction movement driving signals, respectively. Accordingly, the object lens OB is actuated by an extent corresponding to the amount of driving current by x, y and z direction movement driving signals, thereby displacing the light spot irradiated on the hologram recording carrier. Accordingly, a position of the light spot relative to the hologram recording carrier moving in a recording operation keeps constant, thereby securing time to form holograms.

The control circuit 37 generates a slider driving signal based on a position signal from the manipulation part or the pickup position detection circuit 31 and an x direction movement error signal from the servo signal processing circuit 28 and supplies the generated slider driving signal to the slider servo circuit 32. The slider servo circuit 32 moves the pickup 23 in a disk radial direction through the pickup driver 24 according to driving current by the slider driving signal.

The rotation number detection circuit 33 detects a frequency signal indicating a current rotation frequency of the spindle motor 22 rotating a turn table on which the hologram recording carrier 2 is placed, generates a rotation number signal indicating the number of rotation of the spindle motor 22 corresponding to the frequency signal, and supplies the generated rotation number signal to the rotation position detection circuit 34. The rotation position detection circuit 34 generates a rotation position signal and supplies the generated rotation position signal to the control circuit 37. The control circuit 37 generates a spindle driving signal, supplies the generated spindle driving signal to the spindle servo circuit 35, and drives the spindle motor 22 to rotate the hologram recording carrier 2.

<Operation of Hologram Apparatus>

Hereinafter, a case where a reference light component and a signal light component have S polarization in hologram recording and the reference light component has P polarization in hologram reproduction will be described by way of an example. In this example, the polarization selective reflection film 5 of the hologram recording carrier 2 has an optical characteristic of P polarization transmission in S polarization reflection.

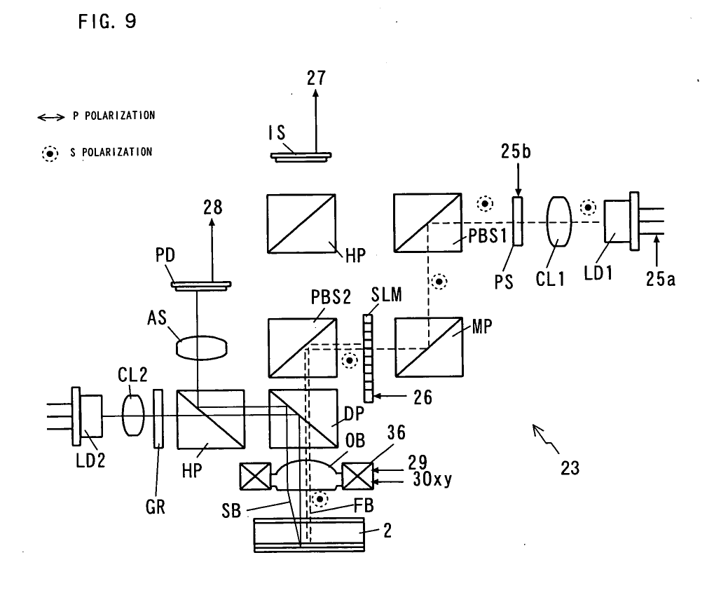

For the hologram recording, as shown in FIG. 9, irradiated coherent light of S polarization (depicted by a circle whose center is dark and whose circumference is denoted by a dashed line, indicating perpendicularity to paper) emitted from the first laser light source LD1 is changed into a parallel light beam by the first collimator lens CL1. The parallel light beam transmits the polarization switch PS and then is incident into the spatial light modulator SLM via the first polarization beam splitter PBS1 and the mirror prism MP (In FIG. 9, the light beam is denoted by a dashed line and is shown deviated from the optical axes shown in FIG. 8 for explanation of an optical path).

The light beam that transmits the spatial light modulator SLM is changed into the first light beam FB having a diffraction light component that undergoes diffraction and a zero-order light component that undergoes no diffraction by a modulation pattern of the spatial light modulator SLM. The diffraction light component becomes the signal light and the zero-order light component becomes the reference light. The first light beam FB keeps S polarization unchanged. The first light beam FB is reflected by the second polarization beam splitter PBS2 and then is condensed on the hologram recording carrier 2 by the object lens OB via the dichroic prism DP. Since the first light beam FB has the S polarization, this beam FB is reflected by the polarization selective reflection film 5 to record a hologram.

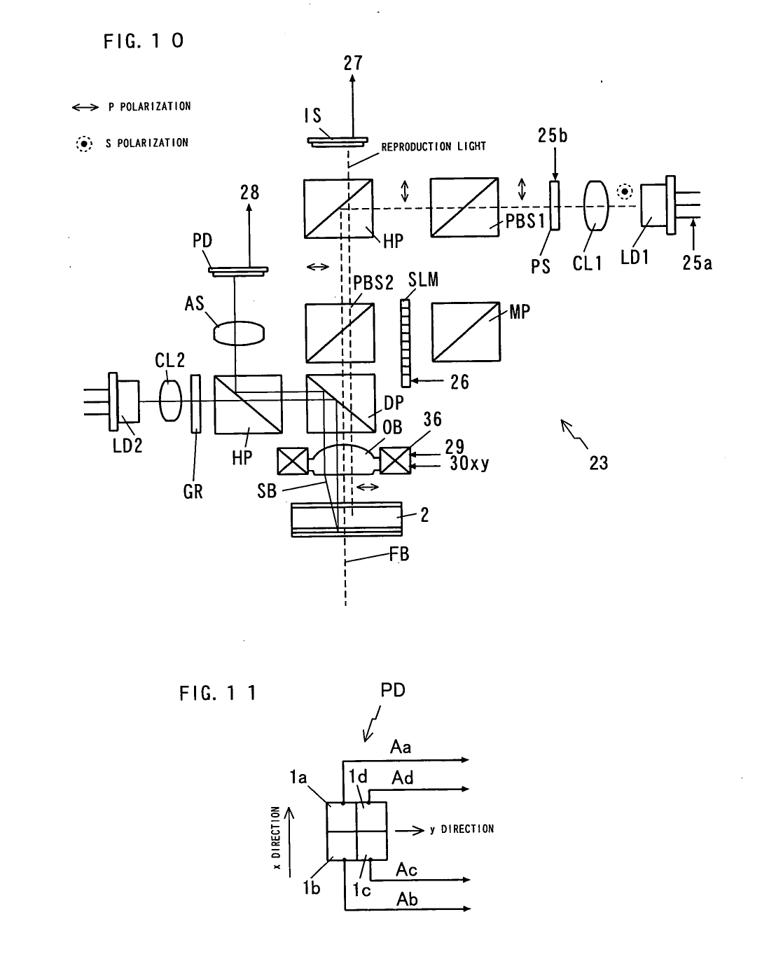

For the hologram reproduction, as shown in FIG. 10, irradiated coherent light of S polarization emitted from the first laser light source LD1 is changed into a parallel light beam by the first collimator lens CL1. The parallel light beam transmits the polarization switch PS. The polarization switch PS rotates polarization direction of the transmitted parallel light beam by 90 degrees. This rotation changes the S polarization to P polarization (depicted by a bidirectional arrow indicating parallelism to paper). The light beam having the P polarization, that is, the first light beam FB (reference light), transmits the first polarization beam splitter PBS1, some of the transmitted first light beam FB reflected by the half mirror prism HP transmits the second polarization beam splitter PBS2 and the dichroic prism DP and then is condensed on the hologram recording carrier 2 through the object lens OB. Since the first light beam FB has the P polarization, this beam FB is not reflected by the polarization selective reflection film 5 of the hologram recording carrier 2, and accordingly, does not return to the pickup 23. Since reproduction light reproduced from the hologram recording carrier 2 has the P polarization, the reproduction light transmits the second polarization beam splitter PBS2 via the dichroic prism DP and then is incident on the image detecting sensor IS. A signal recorded as a hologram is reproduced by the image detecting sensor IS.

The image detecting sensor IS sends its output to the reproduction light signal detection circuit 27, and a reproduction signal generated by the reproduction light signal detection circuit 27 is supplied to the control circuit 37 to reproduce recorded page data.

Here, for both of the hologram recording and reproduction, a servo control for determining the position of the first light beam FB relative to the hologram disk 2 is performed using the servo beam SB. According to such a position determination servo control, a 3-axis actuator (object lens actuating part 36) actuates the object lens OB in three axes of the x, y and z directions using error signals calculated based on output of the photodetector PD.

As shown in FIGS. 9 and 10, the second laser light source LD2 for servo control emits the servo beam SB having a wavelength different from a wavelength of the first laser light source LD1. The servo beam SB is also condensed on the object lens OB, like the first light beam FB. Since polarization direction of the servo beam SB is set to the direction of polarization reflected by the polarization selective reflection film 5 in both of the hologram recording and reproduction (in this example, the S polarization), the servo beam SB is reflected by the polarization selective reflection film 5. The servo beam SB (depicted by thin solid line) having the S polarization leads to the second collimator lens CL2, the diffraction optical element GR and the half prism HP, and then is joined with the first light beam FB (signal light and reference light) on a substantial co-axis by the dichroic prism DP immediately before the object lens OB. The servo beam SB is reflected by the dichroic prism DP, condensed on the object lens OB, and then is incident into the hologram recording carrier 2. Reflected light from the hologram recording carrier 2 (light returning to the object lens OB) is incident along a normal to a light receiving surface of the photodetector PD for servo via the half prism HP and the coupling lens AS.

In addition, a servo control in the z direction (focus servo) may be performed by methods such as an astigmatism method, a three-beam method, a spot size method, a push-pull method and the like, or combinations thereof, used for typical optical pickups.

For example, in the case of the astigmatism method, the coupling lens AS is formed with an astigmatism optical device, and one of centers of the photodetector PD may be constituted by four equally-divided light receiving elements 1a to 1d having respective light receiving surfaces, as shown in FIG. 11. Directions of four division lines of the photodetector PD correspond to a disk radial direction and a track tangential direction. The photodetector PD is so set that the light spot in focusing has a circular shape around a division intersection of the light receiving elements 1a to 1d.

Based on output signals of the light receiving elements 1a to 1d of the photodetector PD, the servo signal processing circuit 28 generates various signals. Assuming that the output signals of the light receiving elements 1a to 1d are Aa to Ad, respectively, a focus error signal FE is calculated by an equation of FE=(Aa+Ac)−(Ab+Ad) and a tracking error signal TE is calculated by an equation of TE=(Aa+Ad)−(Ab+Ac). These signals FE and TE are supplied to the control circuit 37.

<Principle of Recording and Reproduction>

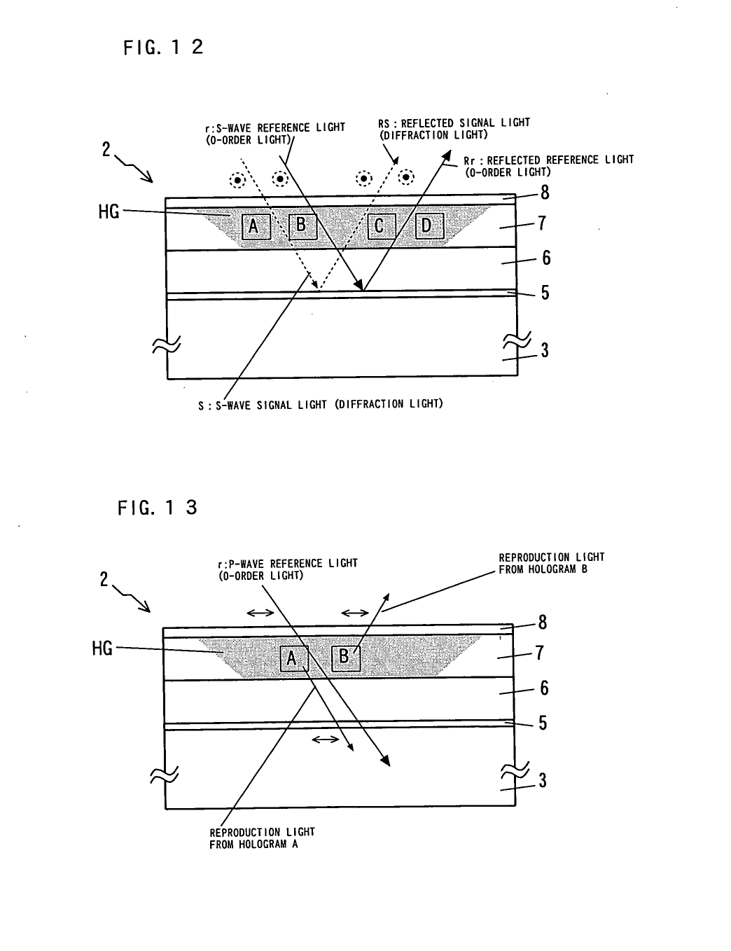

Now, the principle of hologram recording and reproduction in a case where components of the reference light and the signal light is the S polarization for the hologram recording and a component of the reference light is the P polarization for the hologram reproduction will be described by way of an example with reference to FIG. 12. Since a modulation signal modulated by a spatial light modulator (a component of the signal light) has a first-order or more diffraction light component, the modulation signal is spread by some extents near a condensed spot (Fourier plane). Since the polarization selective reflection film 5 is set to reflect a light beam having S polarization, reference light and signal light components are reflected. Holograms are recorded when the component of the reference light of the first light beam FB interferes with the component of the signal light of the first light beam FB in the hologram recording layer 7.

Such interference is possible when a polarization direction of the reference light coincides with that of the signal light. Specifically, as shown in FIG. 12, there exist four interferences and hence four holograms A, B, C and D in the hologram recording layer 7 (In this figure, r (S wave reference light) and Rr (reflected reference light (0—order light) are denoted by a solid arrow, S (S wave signal light) and RS (reflected signal light (diffraction light) are denoted by a dashed arrow, and the holograms A, B, C and D are shown with a rectangular shape.). The hologram A is made by interference between incident reference light r and incident signal light S. The hologram B is made by interference between incident reference light r and reflected signal light RS. The hologram C is made by interference between reflected reference light Rr and incident signal light S. The hologram D is made by interference between reflected reference light Rr and reflected signal light RS.

As shown in FIG. 13, for the hologram reproduction, the reference light is changed from the S polarization to the P polarization by a polarization switch. Since the reference light incident into the hologram recording carrier 2 has the P polarization, the incident reference light is transmitted or absorbed in the polarization selective reflection film 5. For the transmission, the reference light is transmitted to a back side of the hologram recording carrier 2. Accordingly, since there exists no reflected reference light, reproduction light is not produced from the holograms C and D. The reproduction light is reproduced from the holograms A and B recorded by the incident reference light. In this case, the reproduction light reproduced from the hologram A is generated at an opposite side to the object lens OB. Since the reproduction light from the hologram A has the same P polarization as the reference light, the reproduction reference light is transmitted or absorbed in the polarization selective reflection film 5, like the reference light. For the transmission, the reproduction light is transmitted to the back side of the hologram recording carrier 2. As a result, only the reproduction light from the hologram B returns to the object lens OB, and accordingly, unnecessary non-modulated reference light and reproduction light from other holograms as noises are not incident into an image detecting sensor.

In a case where the hologram recording carrier 2 comprises a polarization selective reflection film 5 having a property of P polarization reflection and S polarization transmission, the hologram recording and reproduction can be performed as described above when the hologram recording is performed with P polarization of the reference light and the signal light and the hologram reproduction is performed with S polarization of the reference light. In addition, the reference light and the signal light having the P polarization and the S polarization may be used for the hologram recording. That is, if reflected light having at least one polarization component can be generated from the polarization selective reflection film 5 for the hologram recording, the reproduction light can be detected by only the reference light for reproduction having the other polarization component for the hologram reproduction.

According to the above-described embodiment, since the reference light does not return to a detector, only diffraction light from a hologram required for signal reproduction can be received in the detector. As a result, a reproduction S/N ratio is improved, thereby allowing stable reproduction.

<Another Pickup>

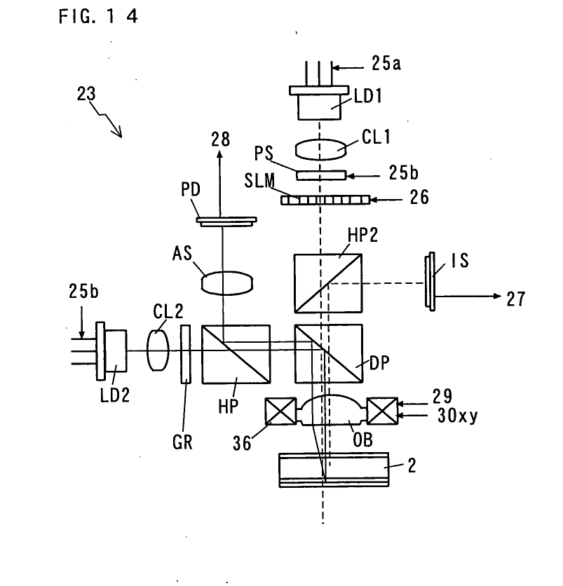

FIG. 14 shows another hologram apparatus in which an optical path of P polarization and S polarization of the reference light and signal light is not divided for the hologram recording and reproduction.

The hologram apparatus shown in FIG. 14 has the same configuration as that shown in FIG. 8 except that the first polarization beam splitter PBS1, the mirror prism MP, the half mirror prism HP and the second polarization beam splitter PBS2 of the optical system shown in FIG. 8 are omitted, a second half mirror prism HP2 is arranged at the position of the second polarization beam splitter PBS2, the first laser light source LD1, the first collimator lens CL1, the polarization switch PS and the spatial light modulator SLM are arranged at the position of the image detecting sensor IS, the image detecting sensor IS is arranged at the position of the mirror prism MP, and the reproduction light returning from the hologram recording carrier through the object lens OB is branched by the second half mirror prism HP2.

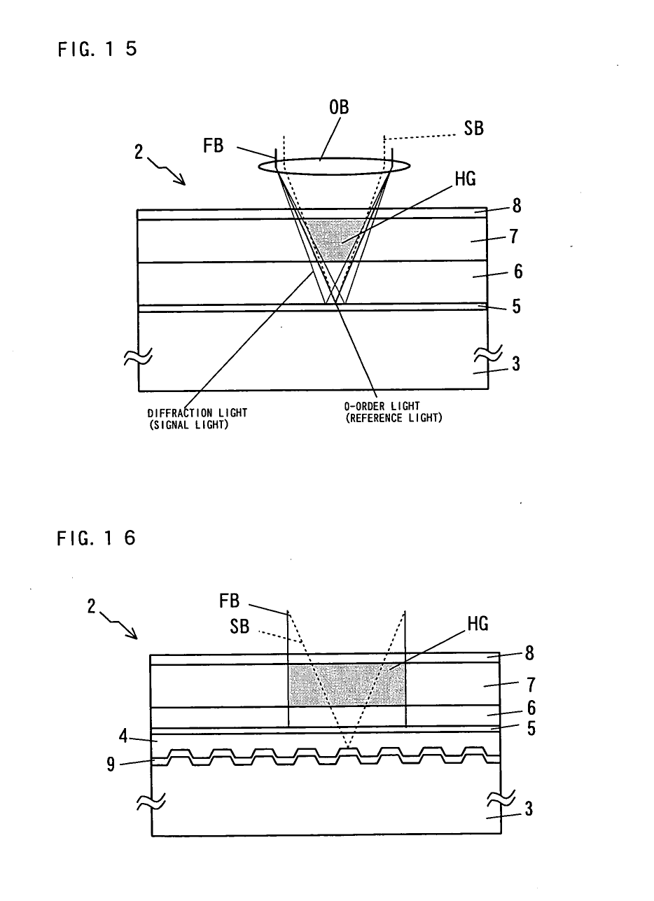

Laser light from the first laser light source LD1 is changed into a parallel light beam by the first collimator lens CL1 and then is incident into the spatial light modulator SLM of a transmission type via the polarization switch PS. The spatial light modulator SLM modulates the parallel light beam according to page data. The first light beam FB outputted from the spatial light modulator SLM and comprising first-order or more diffraction light (signal light component) and non-modulated O-order light (reference light component) is changed into S polarization for recording (P polarization for reproduction) by the polarization switch PS. In addition, the first light beam FB that transmits the second half mirror prism HP2 and the dichroic prism DP is condensed on the hologram recording carrier 2 by the object lens OB. As shown in FIG. 15, since a modulation signal of the first light beam FB modulated by the spatial light modulator (signal light component) has a first-order or more diffraction light component, the modulation signal is spread by some extents near a condensed spot. Accordingly, by interference between the modulation signal (signal light component) and O-order light (reference light component), the same four holograms A to D from incident and reflected S polarization are recorded on the hologram recording layer 7 of the hologram recording carrier 2.

For the hologram reproduction, the first light beam FB comprising only P polarization non-modulated, i.e., O-order light (reference light component) is generated by the polarization switch PS and the spatial light modulator SLM. When the first light beam FB is condensed on the hologram recording carrier 2 through the second half mirror prism HP2, the dichroic prism DP and the object lens OB, reproduction light of forward and backward P polarization is reconstructed, but only the forward P polarization returns to the pickup via the object lens OB by action of the polarization selective reflection film. A light component reflected by the second half mirror prism HP2 is incident into the image detecting sensor IS. The image detecting sensor IS sends an output signal corresponding to an image formed by the reproduction to the reproduction light signal processing circuit 27. A reproduction signal generated in the reproduction light signal processing circuit 27 is supplied to the control circuit to reproduce recorded page data. The servo beam SB is irradiated as S polarization for the hologram recoding and reproduction.

Although a case where both of the reference light and the signal light are the same condensed light has been described in any of the above embodiments, an optical path of the servo beam SB may be separated from an optical path of the first light beam FB (reference light and signal light), and both of the reference light and the signal light may be incident into the hologram recording carrier 2 as parallel light, with the servo beam SB as condensed light, as shown in FIG. 16. In addition, an optical path of the reference light may be separated from an optical path of the signal light and one of the reference light and the signal light may be condensed. In addition, in the same condensed state, the reference may be defocused, or conversely, the signal light may be defocused.

### Embodiment 3

### Another Hologram Recording Carrier

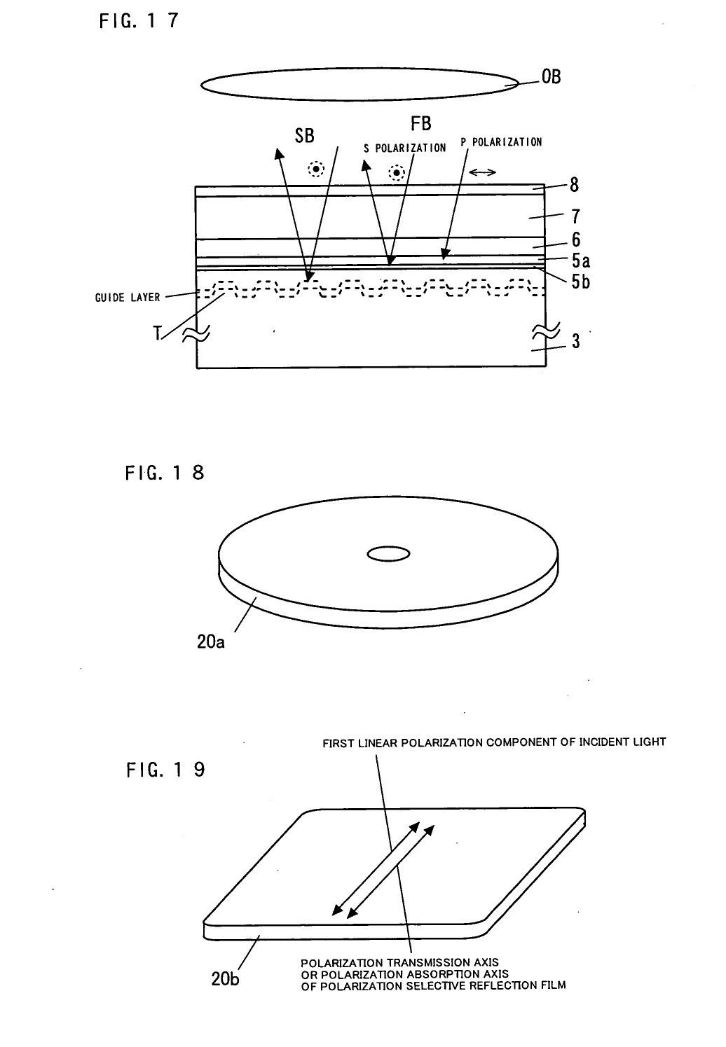

As shown in FIG. 17, the polarization selective reflection film 5 may be constituted by a highly-absorptive polarization film 5a made of a material having high optical absorptiveness by polarization direction from an light irradiation side and a reflection film 5b. Thus, since a first linear polarization component of one of the first light beam FB as incident light, for example, P polarization, is absorbed by the highly-absorptive polarization film 5a, a second linear polarization component, i.e., S polarization, rotated by 90 degrees from the P polarization component can be reflected by the reflection film 5b. The highly-absorptive polarization film 5a transmits predetermined polarization and absorbs polarization in a vibration direction perpendicular to the predetermined polarization. The highly-absorptive polarization film 5a has a polarization transmission axis and a polarization absorption axis. A polarization transmission axis of an absorptive polarization film refers to a direction in which transmitivity becomes maximal when the predetermined polarization is incident in the axis's normal direction. A polarization absorption axis refers to a direction perpendicular to the polarization transmission axis and in which absorptance becomes maximal. The reflection film 5b may comprise a metal film when a stack of the highly-absorptive polarization film 5a and the reflection film 5b is used as a guide layer for servo, but it needs to be made of a material having an optical property of transmitting the servo beam SB (denoted by a dashed line), for example, a wavelength selective reflection film such as a dielectric multi-film, when a separate guide layer (denoted by a dashed line) is farther from a light incidence side than the stack.

### Embodiment 3

### Other Hologram Recording Carriers

Although the disk-like hologram recording carrier 20a as shown in FIG. 18 has been mainly described in the above embodiment, the hologram recording carrier 2 may be a rectangular optical card 20b made of plastics, for example, as shown in FIG. 19.

The card-like hologram recording carrier 20b shown in FIG. 19 is configured to form a specified angle between a polarization plane of a first linear polarization component of incident light and a polarization transmission axis or a polarization absorption axis of the polarization selective reflection film 5, for example, 0 degree (parallel).

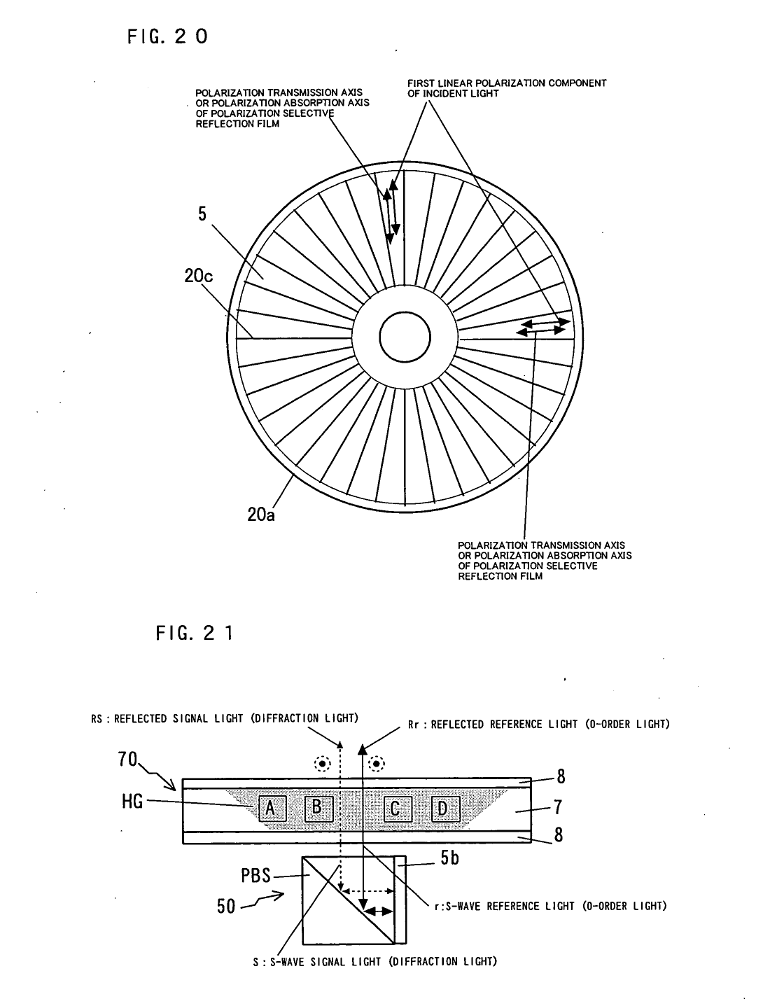

In the disk-like hologram recording carrier 20a as shown in FIG. 18, when one sheet of polarization selective reflection film is attached to the hologram recording layer as it is, an angle of 0 degree can not be maintained between a polarization plane of incident light and a polarization transmission axis or a polarization absorption axis of the polarization selective reflection film when the disk-like hologram recording carrier 2 is rotated. That is, the polarization selective reflection film will not work at any rotation angle in hologram reproduction. This problem can be alleviated when a plurality of fan-shaped polarization selective reflection films 5 (polarization selective reflection films having a polarization transmission axis or a polarization absorption axis maintained in parallel to the polarization plane of the first linear polarization component of the incident light, which coincides with a radial direction) are attached to the hologram recording layer at regular angles, as shown in FIG. 20. The dividing angles of the fan-shaped polarization selective reflection films 5 are set within such an angle range that the fluctuation in the reference light entering the image detecting sensor for reading the signal due to the rotation of the disk is substantially negligible. That is, the polarization transmission axis or the polarization absorption axis of each polarization selective reflection film 5 is set to have a specified angle range (for example, −1 to 1 degree) with the polarization plane of the first linear polarization component of the incident light. In addition, an address region, a servo region and the like are arranged on a division lines 20c extending in the radial direction to prevent the division lines 20c from having an adverse effect on the hologram recording.

### Embodiment 3

### Other Hologram Recording Carrier

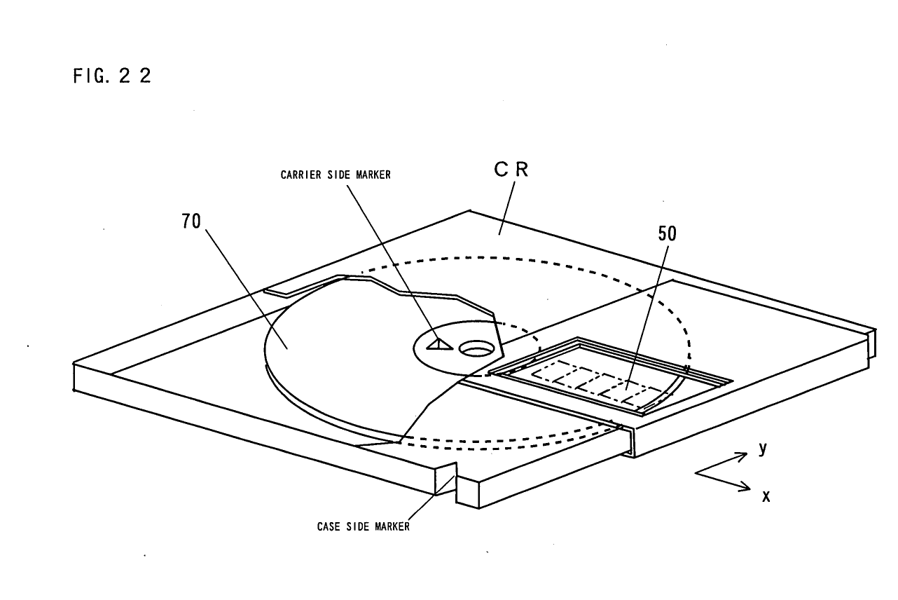

Although the hologram recording carrier having the integrally stacked hologram recording layer and polarization selective reflection film has been described in the above embodiments, as the other embodiment, the hologram recording carrier may be configured to have a polarization selective reflecting part 50 and a recording carrier 70 of a hologram recording layer separately, as shown in FIG. 21. The polarization selective reflecting part 50 may use a combination of a polarization beam splitter PBS separating S polarization and P polarization each other and the reflection film 5b arranged at an emission surface of the S polarization, for example. The recording carrier 70 may has a stacked structure in which a hologram recording layer 7 is sandwiched between two transparent protective layers 8.

In this case, as shown in FIG. 22, the disk-like recording carrier 70 may be received in a case CR and the polarization selective reflecting part 50 may be formed on an inner wall of the case CR. That is, the polarization selective reflecting part 50 is arranged with a space formed at an opposite side to a light irradiation plane of the recording carrier 70. When a position marker of a carrier side engaging with a clamp is formed at a clamp joining part in the center of the disk-like recording carrier 70 and a position marker of a case side for fixation of the case CR to an hologram apparatus is formed at the case CR, a precise alignment between the carrier and the apparatus is possible.

As shown in FIG. 21, since the components of the reference light and the signal light are the S polarization in hologram recoding, the reference light component and the signal light component are reflected by the polarization selective reflecting part 50 via the hologram recording carrier 70. Accordingly, similarly to that shown in FIG. 12, four holograms A to D are recorded on the hologram recording layer 7 of the recording carrier 70.

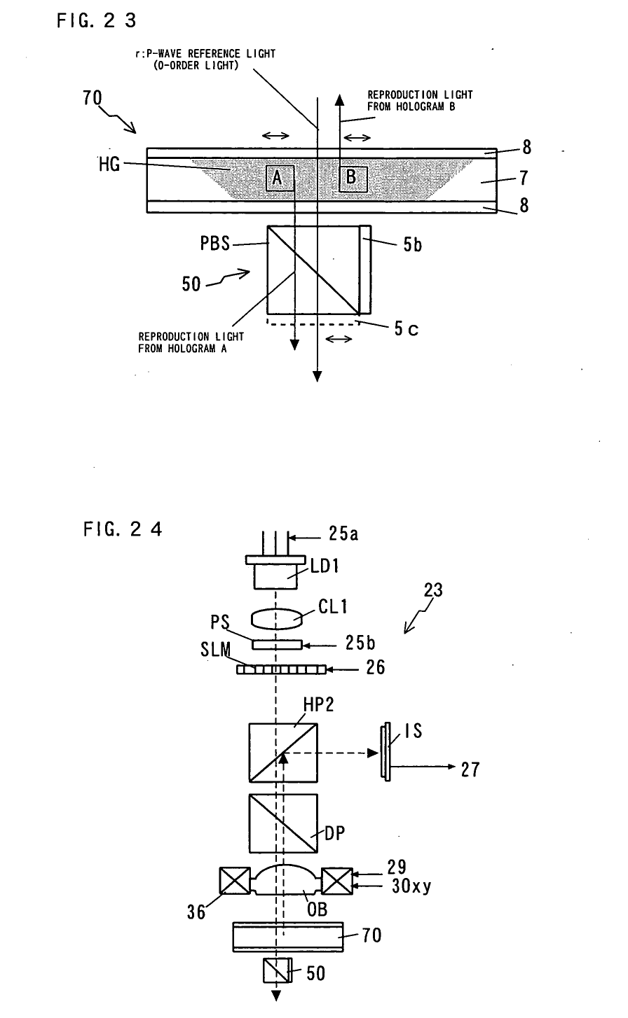

For hologram reproduction, as shown in FIG. 23, since the reference light for hologram reproduction is changed from S polarization to P polarization by the polarization switch of the hologram apparatus, the P polarization is transmitted in the polarization selective reflecting part 50. In addition, as indicated by a dashed line in FIG. 23, a dark absorbing body 5c to absorb the P polarization may be applied on a P polarization emission plane of the polarization beam splitter PBS. Accordingly, since there is no reflected reference light in the hologram recording layer 7, reproduction light is generated from the holograms A and B, not from the holograms C and D. Since P polarization reproduction light from the hologram A is transmitted or absorbed in the polarization selective reflecting part 5, only the reproduction light from the hologram B returns to the object lens side.

FIG. 24 shows another hologram apparatus in which an optical path of P polarization and S polarization of the reference light and the signal light is not divided and the polarization selective reflecting part 50 is arranged with a space formed at an opposite side to the light irradiation plane of the recording carrier 70.

Laser light from the first laser light source LD1 is changed into a parallel light beam by the first collimator lens CL1 and then is incident into the spatial light modulator SLM of a transmission type via the polarization switch PS. The spatial light modulator SLM modulates the parallel light beam according to page data. The first light beam FB outputted from the spatial light modulator SLM and comprising first-order or more diffraction light (signal light component) and non-modulated O-order light (reference light component) is changed into S polarization for recording (P polarization for reproduction) by the polarization switch PS. In addition, the first light beam FB that transmits the second half mirror prism HP2 and the dichroic prism DP is condensed on the hologram recording carrier 70 by the object lens OB. As shown in FIG. 15, since a modulation signal of the first light beam FB modulated by the spatial light modulator (signal light component) has a first-order or more diffraction light component, the modulation signal is spread by some extents near a condensed spot. Accordingly, by interference between the modulation signal (signal light component) and O-order light (reference light component), the same four holograms A to D from incident and reflected S polarization are recorded on the hologram recording layer 7 of the hologram recording carrier 70.

For the hologram reproduction, the first light beam FB comprising only P polarization non-modulated, i.e., O-order light (reference light component) is generated by the polarization switch PS and the spatial light modulator SLM. When the first light beam FB is condensed on the hologram recording carrier 70 through the second half mirror prism HP2, the dichroic prism DP and the object lens OB, reproduction light of forward and backward P polarization is reconstructed, but only the forward P polarization returns to the pickup via the object lens OB by action of the polarization selective reflecting part 50. A light component reflected by the second half mirror prism HP2 is incident into the image detecting sensor IS. The image detecting sensor IS sends an output signal corresponding to an image formed by the reproduction to the reproduction light signal processing circuit 27. A reproduction signal generated in the reproduction light signal processing circuit 27 is supplied to the control circuit to reproduce recorded page data.

In any of the above embodiments, for the hologram recording, the first light beam FB is incident into the hologram recording carrier so that the first light beam FB includes a polarization component reflected by the polarization selective reflection film 5, and, for the hologram reproduction, the first light beam FB including only a polarization component not reflected (i.e., transmitted or absorbed) by the polarization selective reflection film 5 is incident into the hologram recording carrier.

As described above, various holograms are recorded by interference between 4 light beams, that is, the incident reference light and signal light and the reflected reference light and signal light, while only the hologram recorded by the incident reference light is reproduced since the reference light of predetermined polarization is not reflected. Since non-modulated 0—order light is not incident into a sensor receiving reproduction light, an S/N ratio of a reproduction signal is improved. In addition, since the polarization selective reflection film used for hologram recording and reproduction is arranged at a place different from the wavelength selective reflection film, an effect of reference light diffraction from tracks on the wavelength selective reflection film can be reduced.

1. A hologram recording carrier comprising:
a hologram recording layer that stores inside an optical interference pattern made by components of irradiated coherent reference light and signal light, as a diffraction grating; and
a polarization selective reflection film that is arranged on an opposite side to a light irradiation plane of the hologram recording layer and reflects a second linear polarization component rotated from a first linear polarization component, without reflecting the first linear polarization component of incident light.

2. The hologram recording carrier according to claim 1, wherein the polarization selective reflection film has a transmission property of transmitting the first linear polarization component and does not reflect the first linear polarization component.

3. The hologram recording carrier according to claim 1, wherein the polarization selective reflection film has an absorptiveness property of absorbing the first linear polarization component and does not reflect the first linear polarization component.

4. The hologram recording carrier according to claim 3, wherein the polarization selective reflection film comprises an absorptive polarization film absorbing the second linear polarization component rotated from the first linear polarization component, and a reflection film, the absorptive polarization film and the reflection film being stacked in order from a light irradiation side.

5. The hologram recording carrier according to claim 1, wherein the polarization selective reflection film has tracks extending without intersecting therebetween to have a spot of a light beam follow, the light beam passing through the hologram recording layer from an object lens and being focused on the tacks.

6. The hologram recording carrier according to claim 1, further comprising a wavelength selective reflection film that is arranged at an opposite side to the hologram recording layer, with the polarization selective reflection film interposed between the wavelength selective reflection film and the hologram recording layer, transmits the reference light and the signal light, and reflects only a reflection wavelength band which does not include wavelengths of the reference light and the signal light.

7. The hologram recording carrier according to claim 6, wherein the wavelength selective reflection film has tracks extending without intersecting therebetween to have a spot of a light beam follow, the light beam passing through the hologram recording layer and the polarization selective reflection film from an object lens and being focused on the tacks.

8. The hologram recording carrier according to claim 1, wherein information is recorded on the hologram recording layer by irradiation of the reference light and the signal light including the second linear polarization component, and information is reproduced from the hologram recording layer by irradiation of the reference light including only the first linear polarization component.

9. The hologram recording carrier according to claim 1, further comprising a circular substrate on which a plurality of polarization selective reflection films is arranged in a fan-shape.

10. The hologram recording carrier according to claim 9, wherein the plurality of polarization selective reflection films is divided by division lines extending in a radial direction of the substrate, and address regions or servo regions are arranged on the division lines.

11. A hologram recording method of a hologram recording carrier comprising a hologram recording layer that stores inside an optical interference pattern made by components of coherent reference light and signal light, as a diffraction grating, the method comprising the steps of:
arranging a polarization selective reflection film on an opposite side to a light irradiation plane of the hologram recording layer, the polarization selective reflection film transmitting or absorbing a first linear polarization component of incident light, without reflecting the first linear polarization component, and reflecting a second linear polarization component rotated from the first linear polarization component; and
causing a light beam including the second linear polarization component of the reference light and the signal light to be incident from the hologram recording layer into the polarization selective reflection film and to be reflected by the polarization selective reflection film.

12. A hologram reproducing method of a hologram recording carrier comprising a hologram recording layer that stores inside an optical interference pattern made by components of coherent reference light and signal light, as a diffraction grating, the method comprising the steps of:
arranging a polarization selective reflection film on an opposite side to a light irradiation plane of the hologram recording layer, the polarization selective reflection film transmitting or absorbing a first linear polarization component of incident light, without reflecting the first linear polarization component, and reflecting a second linear polarization component rotated from the first linear polarization component; and
causing a light beam including only the first linear polarization component of the reference light to be incident from the hologram recording layer into the polarization selective reflection film and to be transmitted or absorbed in the polarization selective reflection film.

13. A hologram recording and reproducing system comprising:
a supporting part that detachably supports a hologram recording carrier comprising a hologram recording layer that stores inside an optical interference pattern made by components of irradiated coherent reference light and signal light, as a diffraction grating;
a light source that emits the coherent reference light;
a signal light generating part that includes a spatial light modulator for generating signal light by spatially modulating the reference light according to record information; and
an interfering part that irradiates a light beam including the signal light and the reference light on the hologram recording layer, forms a region of diffraction grating by the optical interference pattern inside the hologram recoding layer, and generates reproduction light corresponding to the signal light by irradiating the reference light on the region of diffraction grating,
wherein the hologram recording carrier further comprises a polarization selective reflection film that is arranged on an opposite side to a light irradiation plane of the hologram recording layer and reflects a second linear polarization component rotated from a first linear polarization component, without reflecting the first linear polarization component of the light beam, and
the hologram recording and reproducing system further comprises a polarization variable means that rotates a polarization direction of the reference light to include the second linear polarization component in the light beam for recording and include only the first linear polarization component in the light beam for reproduction.

14. A hologram reproducing system comprising:
a supporting part that detachably supports a hologram recording carrier comprising a hologram recording layer that stores inside an optical interference pattern made by components of irradiated coherent reference light and signal light, as a diffraction grating;
a light source that emits the coherent reference light; and
an interfering part that generates reproduction light corresponding to the signal light by irradiating the reference light on a region of diffraction grating,
wherein the hologram recording carrier further comprises a polarization selective reflection film that is arranged on an opposite side to a light irradiation plane of the hologram recording layer and reflects a second linear polarization component rotated from a first linear polarization component, without reflecting the first linear polarization component of the reference light, and
the hologram reproducing system further comprises a polarization variable means that rotates a polarization direction of the reference light to include only the first linear polarization component in the reference light.

15. A hologram recording and reproducing system comprising:
a supporting part that detachably supports a hologram recording carrier comprising a hologram recording layer that stores inside an optical interference pattern made by components of irradiated coherent reference light and signal light, as a diffraction grating;
a light source that emits the coherent reference light;
a signal light generating part that includes a spatial light modulator for generating signal light by spatially modulating the reference light according to record information;
an interfering part that irradiates a light beam including the signal light and the reference light on the hologram recording layer, forms a region of diffraction grating by the optical interference pattern inside the hologram recoding layer, and generates reproduction light corresponding to the signal light by irradiating the reference light on the region of diffraction grating;
a polarization selective reflecting part that is arranged with a space formed on an opposite side to a light irradiation plane of the hologram recording layer and reflects a second linear polarization component rotated from a first linear polarization component, without reflecting the first linear polarization component of the light beam; and
a polarization variable means that rotates a polarization direction of the reference light to include the second linear polarization component in the light beam for recording and include only the first linear polarization component in the light beam for reproduction.

16. A hologram reproducing system comprising:
a supporting part that detachably supports a hologram recording carrier comprising a hologram recording layer that stores inside an optical interference pattern made by components of irradiated coherent reference light and signal light, as a diffraction grating;
a light source that emits the coherent reference light;
an interfering part that generates reproduction light corresponding to the signal light by irradiating the reference light on a region of diffraction grating;
a polarization selective reflection film that is arranged with a space formed on an opposite side to a light irradiation plane of the hologram recording layer and reflects a second linear polarization component rotated from a first linear polarization component, without reflecting the first linear polarization component of the reference light; and
a polarization variable means that rotates a polarization direction of the reference light to include only the first linear polarization component in the reference light.
